(19) United States
(12) Patent Application Publication
(10) Pub. No.: US 2026/0194188 A1
(43) Pub. Date: Jul. 9, 2026

(54) HYDROGEN MOTORIZATION DEVICE AND METHOD

(71) Applicant: L'Air Liquide, Société Anonyme pour I'Etude et I'Exploitation des Procédés Georges Claude, Paris (FR)

(72) Inventor: Laurent ALLIDIERES, Saint Martin d'Uriage (FR)

(21) Appl. No.: 19/415,130

(22) Filed: Dec. 10, 2025

(30) Foreign Application Priority Data
Jan. 3, 2025 (FR) FR2500021

(51) Int. Cl. F17C 7/04

(52) U.S. Cl. CPC F17C 7/04; F17C 2221/012; F17C 2223/0161; F17C 2225/0123; F17C 2227/0135; F17C 2227/0302; F17C 2227/048; F17C 2260/044

(57) ABSTRACT

A hydrogen motorization device and method including a hydrogen combustion engine, a liquefied hydrogen tank and a transfer circuit connecting the tank to the engine, the transfer circuit including a first transfer line connecting the tank to the engine, the first transfer line being equipped with a pump, the transfer circuit including a second transfer line connecting the hydrogen tank to the engine and configured to transfer pressurized gaseous hydrogen from the tank to the engine by pressure differential, the first transfer line and the second transfer line including a set of valve(s), the device being configured to allow the engine to be supplied with hydrogen via the first transfer line) according to a first mode of direct injection into a compression chamber of the engine or via the second transfer line according to a second mode of injection of the direct mixture with intake air type of the engine.

### CROSS REFERENCE TO RELATED APPLICATIONS

This application claims the benefit of priority under 35 U.S.C. § 119 (a) and (b) to French Patent Application No. FR2500021, filed Jan. 3, 2025, the entire contents of which are incorporated herein by reference.

### BACKGROUND

The invention relates to a hydrogen motorization device and method.

The invention relates more particularly to a hydrogen motorization device comprising a hydrogen combustion engine, a liquefied hydrogen tank and a transfer circuit connecting the tank to the engine, the transfer circuit comprising a first transfer line connecting the tank to the engine, the first transfer line being equipped with a pump configured to pump liquid hydrogen from the tank.

On-board hydrogen storage in vehicles using hydrogen fuel is achieved either in the form of compressed gaseous hydrogen at high pressure (350 or 700 bar for example) or in the form of liquid hydrogen (at a temperature typically of 20 K).

If the required stored capacities are greater than 50 kg, on-board storage in liquid form is preferred.

Liquid hydrogen is generally stored in a low-pressure tank, i.e., at a pressure below 13 bar abs in the case of storage in liquid form, and at a pressure typically below 20 bar in a subcooled liquid form sometimes called “sLH2”.

At equilibrium, the temperature of the hydrogen is fixed by the tank pressure via the saturation curve between the liquid and gaseous phases of hydrogen (valid up to the critical point of hydrogen, at a pressure slightly below 13 bar abs).

Liquid hydrogen is generally produced at a pressure close to atmospheric pressure, generally between 1.15 and 1.3 bar abs, corresponding to a temperature between 20.8K and 21.2 K. This produced liquid hydrogen is transported and transferred into the vehicle's on-board tank using cryogenic trucks and filling stations.

Since transport and transfer are sources of heat input, the minimum temperature of the hydrogen in the tank corresponds to a saturation pressure of around 2 bar abs, or 22.9K.

Hydrogen internal combustion engines (ICE H2) generally operate either with direct injection into the combustion chamber at a pressure greater than 10 bar (between 10 bar and more than 60 bar, and up to 100 bar for certain applications (racing) typically, “Direct Fuel Injection”, or “DFI”) or at a pressure below 10 bar in a direct mixture with the intake air (“Port Fuel Injection”; “PFI”).

Depending on the operating range of the engine, it is more efficient to operate in DFI mode or PFI mode.

The direct coupling of such an engine to a liquid hydrogen tank will not be able to operate in DFI, as the pressure of the liquid hydrogen tank in use is lower than the critical pressure of hydrogen (12 bar) or subcooled liquid “sLH2” (less than 20 bar).

One way to remedy this problem is to insert a cryogenic pump between the tank and the engine in order to raise the hydrogen pressure to a pressure compatible with DFI, typically 30 bar, but which can go up to more than 100 bar in order to increase the engine's efficiency.

The disadvantage of this type of integration is that the pump generates uncompressed vaporization gas due to thermal losses and friction in the pump piston.

This gas is generally returned to the liquid hydrogen tank.

Optimally, the quantity of gas generated is of the order of the quantity necessary to compensate by piston effect for the pumped liquid, i.e., less than 10% of the flow rate produced at high pressure.

However, in several phases of the pump's life this is not the case and it results in a progressive pressure rise in the tank until potentially reaching the set pressure of the so-called “boil-off” valve.

This then causes a release of hydrogen to the atmosphere. This is to be avoided.

### SUMMARY

An object of the present invention is to overcome all or part of the disadvantages of the prior art noted above.

To this end, the device according to the invention, which otherwise conforms to the generic definition given in the preamble above, is essentially characterized in that the transfer circuit comprises a second transfer line connecting the hydrogen tank to the engine, the second transfer line being configured to transfer pressurized gaseous hydrogen from the tank to the engine by pressure differential, the first transfer line and the second transfer line comprising a set of valve(s), the device being configured to allow the engine to be supplied with hydrogen via the first transfer line according to a first mode of direct injection into a compression chamber of the engine or via the second transfer line according to a second mode of injection of the direct mixture with intake air type of the engine.

The device allows the engine supply to operate in PFI mode or DFI mode, for example depending on the engine's life phases.

This makes it possible to control the pressure in the liquid tank (preferably to maintain the tank pressure below the pressure of a relief valve of such a tank).

This makes it possible to avoid releasing gas to the atmosphere.

Furthermore, embodiments of the invention may include one or more of the following features:
the device comprises a vaporization gas return line connecting the pump to the tank and configured to allow the return of vaporization gas generated by pumping to the tank,
the first transfer line comprises at least one of: a hydrogen flow heating system, a pressure reducer,
the hydrogen flow heating system comprises a heat exchanger in thermal exchange with the first transfer line and optionally a bypass system for the heat exchanger to control the flow of hydrogen admitted into the heat exchanger,
the second transfer line comprises at least one of: a hydrogen flow heating system, a pressure reducer,
the hydrogen flow heating system comprises a heat exchanger in thermal exchange with the first transfer line and optionally a bypass system for the heat exchanger to control the flow of hydrogen admitted into the heat exchanger,
the device is configured to allow the engine to be supplied with hydrogen simultaneously via the first transfer line and via the second transfer line, for example according to a ratio between the quantity supplied by the first line and the quantity supplied by the second line comprised between 0 and 30%,
the device is configured to allow the engine to be supplied with hydrogen successively via the first transfer line, via the second transfer line and via the first transfer line and via the second transfer line,
the device comprises an electronic controller configured to control the supply of hydrogen to the engine via the first transfer line and/or via the second transfer line is carried out as a function of a signal representative of the engine's operating mode and/or the pressure in the tank.

The invention also relates to a motorization method using a motorization device conforming to any one of the features above or below, comprising a step of supplying the engine with hydrogen via the first transfer line and/or via the second transfer line as a function of the engine's operating mode and/or the pressure in the tank.

The invention may also relate to any alternative device or method comprising any combination of the features above or below, particularly within the framework of the claims.

### BRIEF DESCRIPTION OF THE FIGURE

The invention will be better understood on reading the following description given only by way of example and with reference to the appended drawings in which:

FIG. 1 is a schematic and partial view illustrating an example of the structure and operation of an exemplary embodiment of the invention.

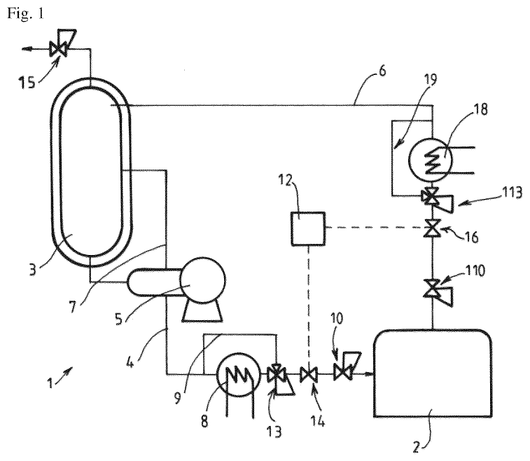

### DETAILED DESCRIPTION OF THE PREFERRED EMBODIMENTS

In the figure, the same references relate to the same elements.

In this detailed description, the following embodiments are examples. Although the description refers to one or more embodiments, this does not mean that the features apply only to a single embodiment. Simple features of different embodiments can also be combined and/or interchanged to provide other embodiments.

The motorization device 1 illustrated comprises a liquefied hydrogen tank 3 and a transfer circuit connecting the tank 3 to an internal combustion engine 2 operating on hydrogen.

The transfer circuit comprises a first transfer line 4 connecting the tank 3 (the liquid part, generally lower) to the engine 2 (in a DFI injection port for example directly into one or more piston compression chambers of the engine 2).

The first transfer line 4 is equipped with a pump 5 configured to pump liquid hydrogen from the tank 3.

The device 1 in this example comprises a vaporization gas return line 7 connecting the pump 5 to the tank 3 and configured to allow the return of vaporization gas generated by pumping to the tank 3.

The first transfer line 4 comprises, arranged in series, a hydrogen flow heating system 8, 9, 13, a valve 14 and a pressure reducer 10.

As illustrated, the hydrogen flow heating system may comprise a heat exchanger 8 ensuring thermal exchange between the first transfer line 4 and a flow of heating fluid.

As illustrated, this heating system may comprise a bypass system 9 for the heat exchanger 8 to control the flow of hydrogen admitted into the heat exchanger 8 (at least part of the hydrogen flow can avoid the heating exchanger 8) via a set of valve(s), for example a three-way valve 13.

This allows the temperature of the hydrogen supplied to the engine 2 to be controlled. The temperature of the injected hydrogen can thus be adjusted to optimize the efficiency of the engine 2 without weakening the injection port (DFI) which may not be suitable for withstanding cryogenic temperatures. The lower the temperature, the better the engine operation because the fluid is denser, up to the injector's operating limit.

The transfer circuit comprises a second transfer line 6 connecting the hydrogen tank 3 to the engine 2. This second transfer line 6, distinct from the first line, is configured to transfer pressurized gaseous hydrogen from the tank 3 to the PFI port of the engine by pressure differential.

The second transfer line 6 is for example connected to the upper part of the tank 3.

The second transfer line 6 comprises, arranged in series, a hydrogen flow heating system 18, 19, 113, a valve 16 and a pressure reducer 110.

As before, the hydrogen flow heating system may comprise a heat exchanger 18 ensuring thermal exchange between the hydrogen of the second transfer line 6 and a flow of heating fluid.

As illustrated, this heating system may comprise a bypass system 19 for the heat exchanger 18 to control the flow of hydrogen admitted into the heat exchanger (at least part of the hydrogen flow can avoid the heating exchanger 18) via a set of valve(s), for example a three-way valve 113.

The device 1 is thus configured to allow the engine 2 to be supplied with hydrogen via the first transfer line 4 (for example according to a first mode of direct injection into a compression chamber of the engine 2) or via the second transfer line 6 (for example according to a second mode of injection of the direct mixture with intake air type of the engine).

In a possible operating mode, the engine's efficiency can be master, i.e., the hydrogen supply is a function of the operating mode of the engine 2.

For example, in the operating ranges of the engine 2 at medium (rotational) speeds, DFI injection is provided. The pump 5 is in operation, drawing low-pressure liquid hydrogen via the first transfer line 4. The pumped liquid hydrogen is heated in the exchanger 8, expanded (pressure reducer 10) and then injected into the engine via the appropriate DFI port.

During this operating mode, the valve 16 of the second transfer line 6 is closed.

The unpumped low-pressure gas generated by pumping is returned to the tank 3 via the return line 7. This can cause the pressure in the tank 3 to rise to the set point of a relief valve 15 of the tank 3.

In the case of low-speed operation of the engine 2 (corresponding to PFI injection), the pump 5 is stopped. The valve 14 of the first transfer line 4 is closed. The relatively low-pressure gaseous hydrogen from the tank 3 is sent directly into the engine 2. This lowers the pressure of the tank 3, for example down to the minimum PFI admission pressure threshold in the engine 2. This pressure threshold may correspond to the set pressure of the pressure reducer 110.

In certain operating ranges (for example at relatively high rotational speeds), the two hydrogen admission modes into the engine 2 can be combined. In this case, the valves 14, 16 of the two lines 4, 6 are open, the pump 5 is active. Hydrogen can be injected into the engine 2 in the DFI and PFI ports.

In a possible operating mode, the injection mode is a function of the pressure in the tank 3. The three supply modes (DFI or PFI or PFI and DFI) can alternate to control the pressure of the tank 3 at the desired level.

The device 1 makes it possible to optimize the integration of a liquid hydrogen tank 3 with an internal combustion engine 2 operating with hydrogen.

The solution makes it possible to guarantee always optimal engine efficiency by alternating the injection modes (DFI or PFI and possibly PFI and DFI) while avoiding the disadvantages associated with cryogenic pumps (evaporation which can lead to hydrogen releases to the air).

This solution makes it possible to avoid operating the engine 2 in PFI mode (low pressure) according to a non-optimized efficiency or operating the engine 2 in DFI mode (with thermal losses related to the pump and the resulting hydrogen losses).

The device also makes it possible to inject cooled hydrogen (temperature between 100K and 300K) into the engine 2 to increase its efficiency.

All or part of the valves can be controlled by an electronic unit 12 comprising a microprocessor.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A hydrogen motorization device comprising:
a hydrogen combustion engine,
a liquefied hydrogen tank, and
a transfer circuit connecting the tank to the engine, the transfer circuit comprising
a first transfer line connecting the tank to the engine, the first transfer line being equipped with a pump configured to pump liquid hydrogen from the tank,
a second transfer line connecting the hydrogen tank to the engine, the second transfer line being configured to transfer pressurized gaseous hydrogen from the tank to the engine by pressure differential,
the first transfer line and the second transfer line comprising a set of valves,
the engine being of the type having two distinct operating modes:
a first mode of direct injection of the fuel into the compression chamber of the engine, and
a second mode of injection of the fuel in direct mixture with the intake air, the two injection modes being carried out by respective distinct inlet ports of the engine,
the device (1) being configured to allow the engine to be supplied with hydrogen via the first transfer line according to the first mode of direct injection into a compression chamber of the engine or via the second transfer line according to the second mode of injection of the direct mixture with intake air type of the engine.

2. The device according to claim 1, further comprising a vaporization gas return line connecting the pump to the tank and configured to allow the return of vaporization gas generated by pumping to the tank.

3. The device according to claim 1, wherein the first transfer line comprises at least one of: a hydrogen flow heating system, a pressure reducer.

4. The device according to claim 3, wherein the hydrogen flow heating system comprises a heat exchanger in thermal exchange with the first transfer line and a bypass system for the heat exchanger to control the flow of hydrogen admitted into the heat exchanger.

5. The device according to claim 1, wherein the second transfer line comprises at least one of: a hydrogen flow heating system, a pressure reducer.

6. The device according to claim 5, wherein the hydrogen flow heating system comprises a heat exchanger in thermal exchange with the first transfer line and a bypass system for the heat exchanger to control the flow of hydrogen admitted into the heat exchanger.

7. The device according to claim 1, wherein the device is configured to allow the engine to be supplied with hydrogen simultaneously via the first transfer line and via the second transfer line according to a ratio between the quantity supplied by the first line and the quantity supplied by the second line comprised between 0 and 30%.

8. The device according to claim 1, wherein the device is configured to allow the engine to be supplied with hydrogen successively via the first transfer line, via the second transfer line and via the first transfer line and via the second transfer line.

9. The device according to claim 8, further comprising an electronic controller configured to control the supply of hydrogen to the engine via the first transfer line and/or via the second transfer line is carried out as a function of a signal representative of the engine's operating mode and/or the pressure in the tank.

10. A motorization method using a motorization device according to claim 1, comprising a step of supplying the engine with hydrogen via the first transfer line and/or via the second transfer line as a function of the engine's operating mode and/or the pressure in the tank.
